(19) United States
(12) Patent Application Publication
(10) Pub. No.: US 2012/0252713 A1
(43) Pub. Date: Oct. 4, 2012

(54) COMPOSITION FOR SURFACE TREATMENT AND PROCESS

(75) Inventors: Richard P. BEATTY, Newark, DE (US); Kuntal CHATTERJEE, St. Louis, MO (US)

(73) Assignee: INVISTA North America S.a.r.l., Wilmington, DE (US)

(21) Appl. No.: 13/242,340

(22) Filed: Sep. 23, 2011

Related U.S. Application Data
(60) Provisional application No. 61/385,983, filed on Sep. 24, 2010.
(60) Provisional application No. 61/446,080, filed on Feb. 24, 2011.
(60) Provisional application No. 61/476,097, filed on Apr. 15, 2011.

(51) Int. Cl. C11D 17/00

(52) U.S. Cl. 510/214

(57) ABSTRACT

These disclosures relate to a composition comprising a combination of chemicals and to a process for using the same composition. This process provides a means to use the composition in cleaning floors and surfaces previously coated with a wax coating for protection of the surface. The composition can include a combination of chemicals selected from microemulsion concentrates based on benzyl alcohol in combination with aqueous ammonia solution.

### FIELD OF THE INVENTION

The disclosures herein relate to a composition comprising a synergistic combination of chemicals and to a process for using the same composition. More particularly, the process uses the composition in cleaning floors and surfaces previously provided with a coating commonly referred to as a wax coating. The combination of chemicals in the composition can be selected from microemulsion concentrates based on benzyl alcohol and tripropylene glycol monomethylether in combination with ammonium hydroxide (aqueous ammonia solution).

### BACKGROUND OF THE INVENTION

The cleaning industry has used aqueous ammonia solution (a.k.a. ammonium hydroxide) in household cleaning for a number of years. One disadvantage of using aqueous ammonia solution is the amount of product required (5%-30% ammonia) and the repulsive ammonia odor associated with the same. As a result, the use of aqueous ammonia solution as a cleaning agent in a substantially closed environment is not practical.

U.S. Pat. No. 4,230,605 discloses a use of a polymeric material, a surfactant, ethylene glycol monobutyl ether and aqueous ammonia as a preferred cleaning composition for no-wax vinyl floors.

The disclosures of U.S. Pat. No. 6,277,800 B1 describe preparation and use of a household cleaning solution based on water, rubbing alcohol and liquid ammonia, in combination with a lemon scented liquid dish detergent.

U.S. Pat. No. 6,403,546 discloses a composition for cleaning and enhancing the gloss of floors using a plasticizer, tributoxyethyl phosphate.

In addition to the above, cleaning compositions for floors and surfaces also use various types of surfactants and solvents, some with a negative environmental impact. For example, high pH products/solutions (i.e., pH 12-13), and environmentally unfriendly solvents, such as phosphates with high solids content (e.g., 15% w/w), can be used.

### SUMMARY OF THE INVENTION

The problem with ammonium hydroxide solutions is the environmental impact of the various solvents and surfactants used to keep the ammonia in solution. Further, the higher the concentration of ammonia, the more solvent and/or surfactants that are required. In addition to the environmental impact, aqueous ammonia also releases a noxious odor, which makes it difficult to use in closed environments.

What is needed are more environmentally friendly solvents and solvent combinations, including combinations that are free of the environmentally unfriendly butyl cellusolve used in floor wax stripping. Further, it would be desirable if the solvents and solvent combinations performed equally to known ammonium hydroxide compositions and have low levels of solids in the composition.

Disclosed herein are composition made from a microemulsion and at least one additional component, including ammonium hydroxide, primary amines, secondary amines, and amino-ethanol. Some of the composition can also have an odor masking agent. Surprisingly, it was found that certain composition performed equally well to known cleaning compositions, while containing less ammonium hydroxide and lower solvent amounts.

In one aspect, an aqueous composition comprising a microemulsion is disclosed; wherein the microemulsion is provided to the composition in an amount of about 1.0% by weight to about 10% by weight, and further comprising one or more components selected from the group consisting of: aqueous ammonia solution (for example, 28-30% by weight, ACS grade), primary amines, secondary amines and amino-ethanol; in an amount of about 0.1% by weight to about 5% by weight, and optionally further comprising an odor masking agent in an amount of about 0.01% by weight to about 3% by weight. The microemulsion can include INVISTA FlexiSolv™ 1150C microemulsion concentrate available from INVISTA or a microemulsion of benzyl alcohol and tripropylene glycol monomethylether.

In another aspect, an aqueous composition comprising a microemulsion comprising benzyl alcohol and tripropylene glycol monomethyl ether is disclosed; wherein the microemulsion is provided to the composition in an amount of about 1.0% by weight to about 10% by weight, and further comprising aqueous ammonia solution (28-30% by weight, ACS grade), in an amount of about 0.1% by weight to about 5% by weight, and optionally further comprising an odor masking agent in an amount of about 0.01% by weight to about 3% by weight.

In a further aspect, the microemulsion is comprised of benzyl alcohol, a nonionic surfactant, an amine component and water. The microemulsion may contain about 33% by weight of benzyl alcohol, about 12% by weight of a nonionic surfactant, about 22% by weight of an amine component and the balance is water. A first additional example can include microemulsions containing from 23 to 43% by weight of benzyl alcohol, about 2 to 22% by weight of a nonionic surfactant, and from 12 to 32% by weight of an amine component, with the balance being water. A second additional example can include microemulsions containing from 28 to 38% by weight of benzyl alcohol, about 7 to 17% by weight of a nonionic surfactant, and from 17 to 27% by weight of an amine component, with the balance being water. A third additional example can include microemulsions containing 30 to 36% by weight of benzyl alcohol, 9 to 15% by weight of a nonionic surfactant, and 19 to 25% by weight of an amine component, with the balance being water.

The nonionic surfactant may be selected from a group comprising alkyl sulfates, alkyl ether sulfates, alkyl ethoxylates, alkali metal salts of sulfo succinates, toluene sulfonates, xylene sulfonates and benzene sulfonates. The amine component may be selected from a group comprising long chained amines, di-amine, cyclic amines, branched di-amines, polyamino substituted alkanes, and C2-C5 alcohol amines. In one embodiment, the amine is a monoalkylamine, for example a monoisoalkyl amine, for example, monoisopropanolamine.

In a further aspect, a process is disclosed for using the aqueous composition to remove wax from surfaces, particularly floor surfaces. The process comprises applying the aqueous composition to the floor or surface and allowing sufficient time for the composition to loosen the wax from the floor or surface. Examples of suitable times for loosen the wax from the floor or surface depend on several factors, including temperature, surface roughness, the amount and composition of wax applied to the floor, and may range from as little as a few seconds to as much as several hours, for example 5 seconds to 20 minutes, 30 seconds to 5 minutes, and 1 to 3 minutes. In one example, the contact time is 12 seconds.

### DETAILED DESCRIPTION

An environmentally friendly aqueous composition is disclosed, which is based upon microemulsions and small quantities of aqueous ammonia to perform comparably to the market products without the negatives of selecting undesirable chemical raw materials or undesirable work conditions (likes fumes, odor). Adding a small amount of ammonia solution, or amines, as an “accelerator” or “adjuvant” improves the performance of the composition in a process of stripping wax from surfaces. The composition can also include an odor masking agent.

One microemulsion that can be used in the disclosed aqueous composition is FlexiSolv™ 1150C from INVISTA.

The disclosed microemulsions are characterized by density (at ˜22° C.) of between 1.0 and 1.1 g/mL, for example 1.01 to 1.07 g/mL, for example 1.02 to 1.05 g/mL, for example 1.035 to 1.045 g/mL.

The disclosed microemulsions are characterized by viscosity (at ˜22° C.) of between 12 and 40 cSt, for example 15 to 38 cSt, for example 17 to 25 cSt.

The disclosed microemulsions are characterized by refractive index values of 1.4 to 1.6 (dimensionless), for example 1.43 to 1.51, for example 1.48 to 1.50.

The disclosed microemulsions are characterized by pH values (when diluted to 10 weight percent in water) of between 4 and 8, for example 4.2 to 7, for example 4.5 to 6.8.

The disclosed microemulsions are characterized by freezing point below 25° C., for example below 20° C., for example below 0° C., for example below 10° C. and below 12° C.

Initial boiling point for the disclosed microemulsion is generally below 220° C., for example.

These emulsions are targeted to household cleaners and with an emphasis on ecologically friendly materials, also called “eco-friendly” solvents. The emulsions can include INVISTA FlexiSolv™ microemulsions, including FlexiSolv™ 1150C, which are clear, single phase solutions that offer strong solvency power in a water-dilutable, water-rinseable system. The FlexiSolv™ microemulsions, when combined with ammonium hydroxide for wax stripping, do not have the negative side-effects of noxious vapors associated with ammonia household cleaners. Further, the FlexiSolv™ microemulsion compositions do not contain environmentally unfriendly chemicals (e.g., butyl cellusolve) and also provide low solids content.

The concentration of microemulsion, including INVISTA FlexiSolv™ in the aqueous composition can range from about 1.0% by weight to about 10% by weight, including between about 2 to about 7% by weight, and between about 3 to about 5% by weight. The concentration of ammonium hydroxide can range from about 0.1% to about 5% by weight, including between about 0.5% to about 3% by weight, and between about 0.8% to about 1.8% by weight.

The ammonium hydroxide can be any suitable grade, for example ACS grade, electronic grade or industrial grade, provided that the ammonium hydroxide does not contain impurities that would be detrimental to the efficacy or stability of the resulting microemulsion.

Also disclosed is a process for stripping wax from floors and surfaces using an aqueous composition comprising a microemulsion and aqueous ammonium hydroxide. The process comprises applying the aqueous composition to the floor or surface and allowing sufficient time as described above for the composition to loosen the wax from the floor or surface. A portion of the loosened wax is entrained in the aqueous composition, so that it may be removed by rinsing the floor or surface. The other portion of the loosened wax is still bonded to the floor or surface, however, the bond strength after application of the aqueous composition is lower than the bond strength before application. This wax may be removed by subsequent applications of the disclosed aqueous composition, or by other mechanical methods such as scrapping, scouring, or scrubbing the floor or surface.

The microemulsion in the disclosed process can include INVISTA FlexiSolv™ 1150C microemulsion concentrate in a concentration from about 1.0 to about 10% by weight, including between about 2 to about 7% by weight; and between about 3 to about 5% by weight. The aqueous ammonium hydroxide is present in a concentration from about 28% to about 30% by weight solution, ACS grade. This results in an ammonium hydroxide concentration in the composition in a range of about 0.1 to about 5% by weight; including between about 0.5 to about 3% by weight; and between about 0.8 to about 1.8% by weight.

Another microemulsion that can be used in the disclosed aqueous compositions and processes is a combination of benzyl alcohol and tripropylene glycol monomethylether. The tripropylene glycol monomethylether is present in a concentration from about 1.0 to about 10% by weight, including about 2 to about 7% by weight, and between about 3 to about 5% by weight.

The disclosed aqueous compositions and processes can also include a substitute for ammonium hydroxide. This substitute can include a compound with a primary amine and/or a secondary amine, and/or an amino ethanol, present in the composition in a concentration range of about 0.1 to about 5% by weight; including between about 0.5 to about 3% by weight; and between about 0.8 to about 1.8% by weight. Examples of suitable primary amines include include methylamine, ethylamine and propylamine. Examples of suitable primary amine alcohols include ethanolamine and propanolamine. Examples of suitable secondary amines include include include dimethylamine. Suitable suitable secondary alcohol amines include methylethanolamine.

One optional component of the composition is an odor masking agent, including d-limonene (1-methyl-4-(1-methylethenyl)-cyclohexene; CAS number 5989-27-5) or a similar florid-smelling odor masking agent (Examples?). The masking agent is present in an amount of between about 0.01 to about 3% by weight. Other optional additives may be included in the composition such as the chelants EDTA, HEDP or MGDA, a thickening agent (e.g., carageenan alone or with sodium stearoyl lactylate); colorants such as dyes and pigments and other fragrances.

Although the foregoing detailed description contains many specifics for the purpose of illustration, a person of ordinary skill in the art will appreciate that many variations and alterations to the following details are within the scope of the herein disclosed embodiments.

A cleaning formulation may be advantageously prepared from ingredients which comprised a blend of solvents selected from the following: benzyl alcohol, substituted benzyl alcohol, aromatic alcohols, dibasic esters, glycerol, glycols and polyols, selected short chain alcohols, alkyl lactate (e.g., ethyl lactate), soy methyl esters and provided in combination with a solubilizing aid; e.g., alkyl sulfates, alkyl ether sulfates, alkyl ethoxylates, alkali metal salts of sulfosuccinate, toluene sulfonate, xylene sulfonate and benzene sulfonate. (the meanings of “substituted” and “alkyl” and the like are usually required to be defined).

The components listed in the foregoing paragraph are combined and mixed by means known in the art (Examples?) with alkyl amines, alkyl diamines, alicyclic amines, branched diamines (e.g., 2-methyl pentamethylene diamine and 2-ethyl tetramethylene diamine), and polyamino substituted alkanes. The resulting product mixture is a continuous fluid phase. This product is diluted with water for cleaning performance testing. Optionally, a small amount of d-limonene is provided to the product as an odor masking agent. The product concentration in a water dilution can be as low as 2 to 4 wt %.

Embodiments of the composition include blends of solvents selected from the following: benzyl alcohol, substituted benzyl alcohol, aromatic alcohols, dibasic esters, glycerol, glycols and polyols, selected short chain alcohols, alkyl lactate (e.g., ethyl lactate), soy methyl esters and provided in combination with a solubilizing aid; e.g., alkyl sulfates, alkyl ether sulfates, alkyl ethoxylates, alkali metal salts of sulfosuccinate, toluene sulfonate, xylene sulfonate and benzene sulfonate. The foregoing components are combined and mixed by means known in the art with alkyl amines, alkyl diamines, alicyclic amines, branched diamines (e.g., 2-methyl pentamethylene diamine and 2-ethyl tetramethylene diamine), and polyamino substituted alkanes. Examples of conventional methods for making microemulsions are taught in textbooks such as Stubenrauch, Cosima, ed., Microemulsions: Background, New Concepts, Applications, Perspectives, New York: Wiley; 2008. Useful surfactants include: linear or branched alcohol ethoxylate, alkyl (EO)(PO) surfactants, alkyl ethoxysulfates, alkylsulfates, toluene/xylene sulfonates, cumene sulfonates, naphthalene sulfonates, BO/PO type block polymeric surfactants) and most specifically alkyl (C9 to C11) ethoxylate (having 8 moles of EO). The resulting product mixture is a continuous fluid phase. This product is diluted with water for cleaning performance testing. Optionally, a small amount of d-limonene is provided to the product as an odor masking agent. The product concentration in a water dilution can be as low as 2 to 4 wt %.

Accordingly, the foregoing aspects are set forth without any loss of generality to, and without imposing limitations upon any claimed invention. It is to be understood that this disclosure is not limited to particular aspects described, as such may vary. It is also to be understood that the terminology used herein is for the purpose of describing particular aspects only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual aspects described and illustrated herein has discrete components and features that may be readily separated from or combined with the features of any of the other several embodiments without departing from the scope or spirit of the present disclosure. Any recited method can be carried out in the order of events recited or in any other order that is logically possible.

Aspects of the present disclosure employ, unless otherwise indicated, techniques of chemistry, and the like, which are within the skill of the art. Such techniques are explained fully in the literature.

The examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for.

Unless indicated otherwise: parts are parts by weight, concentration in % is % by weight (sometimes abbreviated as “wt %”), temperature is in ° C., and pressure is in atmospheres. Pressures reported in pounds per square inch gauge (psig) include the pressure of one atmosphere (14.7 pounds per square inch). One atmosphere is equivalent to 14.7 pounds per square inch absolute or 0 pounds per square inch gauge. Standard temperature and pressure are defined as 25° C. and 1 atmosphere.

It is also to be understood that the terminology used herein is for purposes of describing particular embodiments only, and is not intended to be limiting. It is also possible in the present disclosure that steps can be executed in different sequence where this is logically possible.

The singular forms “a,” “an” and “the” can include plural referents unless the context clearly dictates otherwise.

The term “about” can allow for a degree of variability in a value or range, for example, within 10%, within 5%, or within 1% of a stated value or of a stated limit of a range. When a range or a list of sequential values is given, unless otherwise specified any value within the range or any value between the given sequential values is also disclosed.

The term “organic group” as used herein refers to but is not limited to any carbon-containing functional group. For example, an oxygen-containing group such as alkoxy groups, aryloxy groups, aralkyloxy groups, oxo(carbonyl) groups, carboxyl groups including carboxylic acids, carboxylates, and carboxylate esters; a sulfur-containing group such as alkyl and aryl sulfide groups; and other heteroatom-containing groups. Non-limiting examples of organic groups include OR′, OC(O)N(R′)₂, CN, CF₃, OCF₃, R′, C(O), methylenedioxy, ethylenedioxy, N(R′)₂, SR′, SOR′, SO₂R′, SO₂N(R′)₂, SO₃R′, C(O)R′, C(O)C(O)R′, C(O)CH₂C(O)R′, C(S)R′, C(O)OR′, OC(O)R′, C(O)N(R′)₂, OC(O)N(R′)₂, C(S)N(R′)₂, (CH₂)₀₋₂N(R′)C(O)R′, (CH₂)₀₋₂N(R)N(R′)₂, N(R′)N(R′)C(O)R′, N(R)N(R′)C(O)OR′, N(R′)N(R′)CON(R′)₂, N(R′)SO₂R′, N(R′)SO₂N(R′)₂, N(R′)C(O)OR′, N(R)C(O)R′, N(R′)C(S)R′, N(R′)C(O)N(R′)₂, N(R′)C(S)N(R′)₂, N(COR′)COR′, N(OR′)R′, C(═NH)N(R′)₂, C(O)N(OR′)R′, or C(═NOR′)R′ wherein R′ can be hydrogen (in examples that include other carbon atoms) or a carbon-based moiety, and wherein the carbon-based moiety can itself be further substituted; for example, wherein R′ can be hydrogen (in examples that include other carbon atoms), alkyl, acyl, cycloalkyl, aryl, aralkyl, heterocyclyl, heteroaryl, or heteroarylalkyl, wherein any alkyl, acyl, cycloalkyl, aryl, aralkyl, heterocyclyl, heteroaryl, or heteroarylalkyl, or R′ can be independently mono- or multi-substituted with J; or wherein two R′ groups bonded to a nitrogen atom or to adjacent nitrogen atoms can together with the nitrogen atom or atoms form a heterocyclyl, which can be mono- or independently multi-substituted with J. Examples of organic groups include linear and/or branched groups such as alkyl groups, fully or partially halogen-substituted haloalkyl groups, alkenyl groups, alkynyl groups, aromatic groups, acrylate functional groups, and methacrylate functional groups; and other organic functional groups such as ether groups, cyanate ester groups, ester groups, carboxylate salt groups, and masked isocyano groups. Examples of organic groups include, but are not limited to, alkyl groups such as methyl, ethyl, propyl, isopropyl, n-butyl, s-butyl, and t-butyl groups, acrylate functional groups such as acryloyloxypropyl groups and methacryloyloxypropyl groups; alkenyl groups such as vinyl, allyl, and butenyl groups; alkynyl groups such as ethynyl and propynyl groups; aromatic groups such as phenyl, tolyl, and xylyl groups; cyanoalkyl groups such as cyanoethyl and cyanopropyl groups; halogenated hydrocarbon groups such as 3,3,3-trifluoropropyl, 3-chloropropyl, dichlorophenyl, and 6,6,6,5,5,4,4,3,3-nonafluorohexyl groups; alkenyloxypoly(oxyalkyene) groups such as allyloxy(polyoxyethylene), allyloxypoly(oxypropylene), and allyloxy-poly(oxypropylene)-co-poly(oxyethylene) groups; alkyloxypoly(oxyalkyene) groups such as propyloxy(polyoxyethylene), propyloxypoly(oxypropylene), and propyloxy-poly(oxypropylene)-co-poly(oxyethylene) groups; halogen substituted alkyloxypoly(oxyalkyene) groups such as perfluoropropyloxy(polyoxyethylene), perfluoropropyloxypoly(oxypropylene), and perfluoropropyloxy-poly(oxypropylene)-co-poly(oxyethylene) groups; alkoxy groups such as methoxy, ethoxy, n-propoxy, isopropoxy, n-butoxy, and ethylhexyloxy groups; aminoalkyl groups such as 3-aminopropyl, 6-aminohexyl, 11-aminoundecyl, 3-(N-allylamino)propyl, N-(2-aminoethyl)-3-aminopropyl, N-(2-aminoethyl)-3-aminoisobutyl, p-aminophenyl, 2-ethylpyridine, and 3-propylpyrrole groups; epoxyalkyl groups such as 3-glycidoxypropyl, 2-(3,4,-epoxycyclohexyl)ethyl, and 5,6-epoxyhexyl groups; ester functional groups such as actetoxyethyl and benzoyloxypropyl groups; hydroxy functional groups such as 2-hydroxyethyl groups; masked isocyanate functional groups such as propyl-t-butylcarbamate, and prop ylethylcarbamate groups; aldehyde functional groups such as undecanal and butyraldehyde groups; anhydride functional groups such as 3-propyl succinic anhydride and 3-propyl maleic anhydride groups; and metal salts of carboxylic acids such as the zinc, sodium, or potassium salts of 3-carboxypropyl and 2-carboxyethyl.

The term “substituted” as used herein refers to an organic group as defined herein or molecule in which one or more bonds to a hydrogen atom contained therein are replaced by one or more bonds to a non-hydrogen atom. The term “functional group” or “substituent” as used herein refers to a group that can be or is substituted onto a molecule, or onto an organic group. Examples of substituents or functional groups include, but are not limited to, a halogen (e.g., F, Cl, Br, and I); an oxygen atom in groups such as hydroxyl groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups. Non-limiting examples of substituents J that can be bonded to a substituted carbon (or other) atom include F, Cl, Br, I, OR′, OC(O)N(R′)₂, CN, NO, NO₂, ONO₂, azido, CF₃, OCF₃, R′, O (oxo), S (thiono), C(O), S(O), methylenedioxy, ethylenedioxy, N(R′)₂, SR′, SOR′, SO₂R′, SO₂N(R′)₂, SO₃R′, C(O)R′, C(O)C(O)R′, C(O)CH₂C(O)R′, C(S)R′, C(O)OR′, OC(O)R′, C(O)N(R)₂, OC(O)N(R′)₂, C(S)N(R′)₂, (CH₂)₀₋₂N(R′)C(O)R′, (CH₂)₀₋₂N(R′)N(R′)₂, N(R′)N(R′)C(O)R′, N(R′)N(R′)C(O)OR′, N(R′)N(R′)CON(R)₂, N(R′)SO₂R′, N(R′)SO₂N(R′)₂, N(R′)C(O)OR′, N(R′)C(O)R′, N(R′)C(S)R′, N(R′)C(O)N(R′)₂, N(R′)C(S)N(R′)₂, N(COR′)COR′, N(OR′)R′, C(═NH)N(R′)₂, C(O)N(OR')R′, or C(═NOR′)R′ wherein R′ can be hydrogen or a carbon-based moiety, and wherein the carbon-based moiety can itself be further substituted; for example, wherein R′ can be hydrogen, alkyl, acyl, cycloalkyl, aryl, aralkyl, heterocyclyl, heteroaryl, or heteroarylalkyl, wherein any alkyl, acyl, cycloalkyl, aryl, aralkyl, heterocyclyl, heteroaryl, or heteroarylalkyl or R′ can be independently mono- or multi-substituted with J; or wherein two R′ groups bonded to a nitrogen atom or to adjacent nitrogen atoms can together with the nitrogen atom or atoms form a heterocyclyl, which can be mono- or independently multi-substituted with J.

The term “alkyl” as used herein refers to straight chain and branched alkyl groups and cycloalkyl groups having from 1 to about 20 carbon atoms, and typically from 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain fauns of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to about 20 carbon atoms, and typically from 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to about 20 carbon atoms, and typically from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is also bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-20 additional carbon atoms bonded to the carbonyl group. An acyl group can include double or triple bonds within the meaning herein. An acryloyl group is an example of an acyl group. An acyl group can also include heteroatoms within the meaning here. A nicotinoyl group (pyridyl-3-carbonyl) group is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4- 2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

The term “heteroaryl” as used herein refers to aromatic ring compounds containing 5 or more ring members, of which, one or more is a heteroatom such as, but not limited to, N, O, and S; for instance, heteroaryl rings can have 5 to about 8-12 ring members. A heteroaryl group is a variety of a heterocyclyl group that possesses an aromatic electronic structure. A heteroaryl group designated as a C₂-heteroaryl can be a 5-ring with two carbon atoms and three heteroatoms, a 6-ring with two carbon atoms and four heteroatoms and so forth Likewise a C₄-heteroaryl can be a 5-ring with one heteroatom, a 6-ring with two heteroatoms, and so forth. The number of carbon atoms plus the number of heteroatoms sums up to equal the total number of ring atoms. Heteroaryl groups include, but are not limited to, groups such as pyrrolyl, pyrazolyl, triazolyl, tetrazolyl, oxazolyl, isoxazolyl, thiazolyl, pyridinyl, thiophenyl, benzothiophenyl, benzofuranyl, indolyl, azaindolyl, indazolyl, benzimidazolyl, azabenzimidazolyl, benzoxazolyl, benzothiazolyl, benzothiadiazolyl, imidazopyridinyl, isoxazolopyridinyl, thianaphthalenyl, purinyl, xanthinyl, adeninyl, guaninyl, quinolinyl, isoquinolinyl, tetrahydroquinolinyl, quinoxalinyl, and quinazolinyl groups. Heteroaryl groups can be unsubstituted, or can be substituted with groups as is discussed herein. Representative substituted heteroaryl groups can be substituted one or more times with groups such as those listed herein.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include one to about 12-20 carbon atoms bonded to the oxygen atom, and can further include double or triple bonds, and can also include heteroatoms. For example, an allyloxy group is an alkoxy group within the meaning herein. A methoxyethoxy group is also an alkoxy group within the meaning herein, as is a methylenedioxy group in a context where two adjacent atoms of a structures are substituted therewith.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary or quaternary amino group. An “alkylamino” group includes a monoalkylamino, dialkylamino, and trialkylamino group.

The terms “halo” or “halogen” or “halide”, as used herein, by themselves or as part of another substituent mean, unless otherwise stated, a fluorine, chlorine, bromine, or iodine atom, preferably, fluorine, chlorine, or bromine.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “monovalent” as used herein refers to a substituent connecting via a single bond to a substituted molecule. When a substituent is monovalent, such as, for example, F or Cl, it is bonded to the atom it is substituting by a single bond.

The term “hydrocarbon” as used herein refers to a functional group or molecule that includes carbon and hydrogen atoms. The term can also refer to a functional group or molecule that normally includes both carbon and hydrogen atoms but wherein all the hydrogen atoms are substituted with other functional groups.

The term “solvent” as used herein refers to a liquid that can dissolve a solid, liquid, or gas. Nonlimiting examples of solvents are organic compounds, water, alcohols, ionic liquids, and supercritical fluids.

The term “independently selected from” as used herein refers to referenced groups being the same, different, or a mixture thereof, unless the context clearly indicates otherwise. Thus, under this definition, the phrase “X¹, X², and X³ are independently selected from noble gases” would include the scenario where, for example, X¹, X², and X³ are all the same, where X¹, X², and X³ are all different, where X¹ and X² are the same but X³ is different, and other analogous permutations.

“Microemulsion”, as used herein, is a specific type of emulsion where the size of the dispersed phase droplets (typically <100 nm in diameter) is small compared to the wavelength of light, making the microemulsion appear clear and transparent to the eye when observed under diffuse, multidirectional light. Tyndall effect light scattering can generally be observed when a sample is illuminated by a collimated beam of light and an observer views the sample from an angle relative to the path of the light beam, such as an angle of from about 20 degrees to about 160 degrees, for example an angle of from about 45 degrees to about 135 degrees, for example an angle of about 90 degrees. Usually gentle mixing is sufficient to form a microemulsion. Microemulsions are thermodynamically stable and do not spontaneously separate.

“Microemulsion concentrate”, as used herein, is a composition comprising one liquid phase and a surfactant package that, when combined with a second liquid phase immiscible with the first liquid phase, forms a microemulsion.

“Substituent” as used herein means a branch from a parent structure.

### Test Methods

BYK- Gardner Instrument USA (9104 Guilford Road, Columbia, Md. 21046-2729 United States; BYK-Gardner GmbH, Lausitzer StraBe 882538 Geretsried, Germany) is used to check performance of wax cleaning from “soiled” tiles. Details of the test method are explained in the example.

Color is measured using the HunterLab Ultrascan Pro, or equivalent, color measurement spectrophotometer from Hunter Associates Laboratory Inc., Reston, Va., USA. Color is rated on the color scale Hunter L,a,b. As one skilled in the art of color measurement would know, the L,a,b scales simulates color as:
L (lightness or luminance) axis—0 is black, 100 is white
a (red-green) axis—positive values are red; negative values are green and 0 is neutral
b (yellow-blue) axis—positive values are yellow; negative values are blue and 0 is neutral.

All colors visually perceivable are measurable in L,a,b scale. The scale can also measure the color difference between a sample and a standard.

### EXAMPLES

The following examples are provided to illustrate the various aspects of the disclosed compositions and processes. It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also the individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±8%, or ±10%, of the numerical value(s) being modified. In addition, the phrase “about ‘x’ to ‘y’” includes “about ‘x’ to about ‘y’”.

### Example 1

In an example the following test method is employed.

Preparation of tiles for soiling: eight (8) vinyl 4″ tiles are cleaned with a glass cleaner, rinsed and dried in 40° C. oven with nitrogen (N₂) purge for 2 hours. After cooling to room temperature the color coordinate “L” of the wax-free tiles is measured and recorded as L1 and the tiles are ready to be soiled with “dirty wax”.

Preparing Wax Stains: 500 g Red Max Pro Low Maintenance Floor Finish Item #216595 (a wax dispersion commercially available from Enforcer Products, a division of Acuity Products Inc., PO Box 1060, Cartersville, Ga. 30120, USA) is prepared with 1.0 g lampblack dispersed in the wax dispersion and homogenized for one (1) minute to form a dispersion. This wax-lampblack dispersion is subsequently rolled on the tile with a paint roller. Four (4) coats are applied and measured visually. (Whizz roller #94062) 15 minutes between coats to dry. The soiled tiles are air dried for 30 minutes; then dried in 40° C. oven for 18 hours. Once the soiled tiles are cooled, the color coordinate “L” is measured and recorded as L2. These “dirty tiles” are ready for cleaning.

Cleaning Test: Soiled tiles are cleaned on a BYK Gardner Abrasion tester set (number of cycles can vary, but typically up to 30 cycles). A cleaning sponge is placed in hard water (hardness?) and excess water squeezed out. Tiles are soaked in cleaner (lying flat in a pan, face up) for two minutes and then supported vertically to drain for 15 seconds.

Tile is placed in the tile in BYK Abrasion tester run full 30 cycles. The number of cycles to clean and visual percent (%) clean is recorded.

Performance Evaluation: After running the desired number of cycles for cleaning, the tiles are rinsed in tap water 3 times (dipping) and supported at an angle to dry. After drying, color coordinate “L” measurements of the cleaned tiles are taken and recorded as L3. The cleaning effectiveness, or percent cleaned, is calculated according to the formula (L3−L2)/(L1−L2)×100% where L1, L2, and L3 are as defined above.

Cleaning of Wax Stained hard PVC Floor Tiles.

### Results—Part 1.

| | | # | # of | Cleaning |
|---|---|---|---|---|
| | | of | cycles | effectiveness |
| Tile # | Cleaning Formulation tested | cycl [symbol] | clean | (% cleaned) |
| 1. | Red Max Pro Heavy Duty Floor | 30 | | 10 |
| | Stripper diluted 1:8 | | | |
| 2. | Red Max Pro Heavy Duty Floor | 30 | | 10 |
| | Stripper diluted 1:8 | | | |
| 3. | FlexiSolv ™ 1100 C. | 30 | | 0 |
| | microemulsion concentrate | | | |
| | (3.3 wt %)-96.7 wt % water | | | |
| 4. | FlexiSolv ™ 1100 C. | 30 | | 0 |
| | microemulsion concentrate | | | |
| | (3.3 wt %)-96.7 wt % water | | | |
| 5. | FlexiSolv ™ 1150 C. | 30 | | 0 |
| | microemulsion concentrate | | | |
| | (3.3 wt %)-96.7 wt % water | | | |
| 6. | FlexiSolv ™ 1150 C. | 200 | | 5 |
| | microemulsion concentrate | | | |
| | (3.3 wt %)-96.7 wt % water | | | |
| 7. | FlexiSolv ™ 1150 C. | 200 | | 5 |
| | microemulsion concentrate | | | |
| | (3.3 wt %)-96.7 wt % water | | | |
| 8. | Red Max Pro Heavy Duty Floor | 200 | | 90 |
| | Stripper diluted 1:8 | | | |

Notes on Results.
1. If the tile is clean in less than 30 cycles, then the number of cycles required to clean is listed in the column entitled “# of cycles to clean.”
2. Red Max Pro Heavy Duty Floor Stripper is manufactured by: Zep Inc., 1310 Seaboard Ind. Blvd., Atlanta, GA 30318, USA.
3. Floor Star ™ Service Master Power Strip Concentrate #32955 is commercially available from Service Master Clean of Memphis, TN. [symbol]
indicates data missing or illegible when filed

### Results—Part 2.

| | | | # of | Cleaning |
|---|---|---|---|---|
| | | # of | cycles | effectiveness |
| Tile # | Cleaning Formulation tested | cycles | to clean | (% cleaned) |
| 1. | Red Max Pro Heavy Duty Floor Stripper | 30 | | 75 |
| | diluted 1:8 | | | |
| 2. | Floor Star ™ Service Master Power Strip | 30 | | 80 |
| | Concentrate at 1:15 dilution | | | |
| 3. | FlexiSolv ™ 1150 C. microemulsion | 30 | 10 | 100 |
| | concentrate (3.25 wt %), NH4OH (1.5 wt %), | | | |
| | d-Limonene (0.5 wt %) + 95 wt % water | | | |
| 4. | FlexiSolv ™ 1150 C. microemulsion | 30 | 7 | 100 |
| | concentrate (3.25 wt %), NH4OH (1.5 wt %), | | | |
| | no d-Limonene + 95.5 wt % water | | | |
| 5. | NH₄OH (1.5 wt %) + 98.5 wt % water | 30 | | 10 |
| 6. | FlexiSolv ™ 1150 C. microemulsion | 30 | | 0-5 |
| | concentrate (3.3 wt %)-96.7 wt % water | | | |
| 8. | Red Max Pro Heavy Duty Floor Stripper | 200 | | 90 |
| | diluted 1:8 | | | |

### Results—Part 3.

| | | | | Cleaning |
|---|---|---|---|---|
| | | # of | # of cycles | effectiveness |
| Tile # | Cleaning Formulation tested | cycles | to clean | (% cleaned) |
| 1. | Red Max Pro Heavy Duty Floor Stripper diluted | 30 | | 70 |
| | 1:8 | | | |
| 2. | Floor Star ™ Service Master Power Strip | 30 | | 80 |
| | Concentrate at 1:15 dilution. | | | |
| 3. | Red Max Pro Heavy Duty Floor Stripper, full | 30 | 5 | 100 |
| | strength | | | |
| 4. | Floor Star ™ Service Master Power Strip | 30 | 4 | 100 |
| | Concentrate, Full Strength | | | |
| 5. | FlexiSolv ™ 1150 C. microemulsion concentrate | 30 | 5 | 100 |
| | (3.25%), NH₄OH (1.5%), d-Limonene (0.5%) + | | | |
| | 95% water - Fresh sample | | | |
| 6. | Sample #5, in oven (50 C) - 1 day | 30 | 4 | 100 |
| 7. | Sample #5, in oven (50 C) - 5 days | 30 | 5 | 100 |
| 8. | Sample #5, in oven (50 C) - 10 days | 30 | 6 | 100 |

Results for tile #1 in Part 2 were slightly better than for tile #1 in Part 3; thus the rating of 75% in Part 2 vs. 70% in Part 3.

### Example 2

The compositions of Example 2 illustrate effective cleaning formulations prepared from water, an amine such as an alkyl amine or an alkanolamine, benzyl alcohol or phenoxy ethanol and a surfactant. Suitable amines include monoamines, diamines and triamines, merely to name a few examples.

### Example 2a

Water, an amine or alkanolamine, benzyl alcohol, and a surfactant are mixed according to known methods in the art (we recommend further describing the specific preparation method) to form a continuous fluid phase composition and described below as Test Solutions A, B and C. These cleaning formulations may be used directly in the cleaning applications disclosed herein.

| | | Cycles | Visual % | |
|---|---|---|---|---|
| Tile # | Product being evaluated | need | clean | Observations |
| 1 | Commercial product #1 Red Max Pro Heavy | 30 | 60% | Not clean |
| | Duty Floor Stripper (1:8 dilution) | | | |
| 2 | Commercial product #2 Floor Star ™ Service | 30 | 40% | Not clean |
| | Master Power Strip Concentrate (1:15 dilution) | | | |
| 3 | Test solution, A (4%) - balance water | 9 | 100 | Very clean |
| 4 | Test solution B (4%) - balance water | 5 | 98 | very clean |
| 5 | Test solution B (4%) - balance water | 3 | 93 | clean |
| 6 | Test solution B (4%) + 4% NaOH - balance water | 3 | 100 | Very clean |
| 7 | Test solution C (4%) - balance water | 30 | 50 | not clean |

Test Solution A Formulation consists of - 33.4% benzyl alcohol/21.6% 1,3-pentane diamine/11.6% surfactant (Tomadol 9-11(8))/rest water
Test Solution B Formulation consists of - 36.6% benzyl alcohol/24.75% monoisopropanolamine/1.98% surfactant (Tomadol 9-11(8))/rest water
Test Solution C Formulation consists of - 29.1% benzyl alcohol/11.3% monoisopropanolamine/30.5% surfactant (Tomadol 9-11(8))/rest water
we recommend providing the information about Tomadol 9-11(8).

### Example 2b

A select blend of solvents consisting of benzyl alcohol, substituted benzyl alcohol, other aromatic alcohols, dibasic esters, glycerol, glycols and polyols, select short chain alcohol, alkyl lactate (ethyl preferred), soy methyl esters in combination with a solubilizing aid such as alkyl sulfates, alkyl ether sulfates, alkyl ethoxylates, alkali metal salts of sulfo succinates, toluene and xylene sulfonates, or benzene sulfonates were mixed with long chain amines, di-amine, cyclic amines, branched di amines, and polyamino substituted alkanes. This mixture was a single phase product and diluted to the appropriate levels for testing. Optionally, a small amount of d-limonene was used as an odor masking agent in the finished formulation. Product concentration in use were as low as 2 to 4 wt % in use which would be attractive to an end user due to the high concentration of the product (less transportation costs associated with inert ingredients like water).

### Ingredients:

The composition of the test solution is shown in the following table.

| Ingredients | Part by wt % |
|---|---|
| Benzyl alcohol | 33% |
| 1,3-pentanediamine | 22% |
| C9-C11 alcohol ethoxylate(8) | 12% |
| Water | balance |

### Experimental Results for Example 2b

The product shown in the table above was mixed with select amine/ammonia solution and diluted to the levels of interest and were tested for wax removing efficacy (We recommend defining the name and concentration of the amine/ammonia solution used for the aqueous composition in the following table). Results are shown below:

| | | | Visual | |
|---|---|---|---|---|
| | | Cycles | % | Observation, |
| Tile # | Product being evaluated | need | clean | inferences |
| 1 | Commercial product #1 | 30+ | 95 | |
| 2 | Commercial product #2 | 30+ | 92 | |
| 3 | Test solution (4%) - rest | 3 | 100 | Comes out very |
| | water | | | clean |
| 4 | Test solution (6%) - rest | 2 | 100 | Same as above |
| | water | | | |
| 5 | Test solution (8%) - rest | 1 | 100 | Same as above |
| | water | | | |
| 6 | Test solution (2%) - rest | 30+ | 90 | Not perfectly clean - |
| | water | | | like Commercial |
| | | | | Product #1 |
| 7 | Test solution (4%) - rest | 3 | 100 | Very clean |
| | water | | | |

NOTES:
Some Commercial Products were tested to their full strength as well as the recommended dilutions.
Test products were tested to the recommended dilutions as well.

While various aspects have been disclosed herein, other aspects will be apparent to those skilled in the art. The various aspects disclosed herein are for purposes of illustration and are not intended to be limiting, with the true scope and spirit being indicated by the following claims.

What is claimed is:

1. An aqueous composition comprising a microemulsion, wherein the microemulsion is provided to the composition in amount of 1.0% by weight to 10% by weight and further comprising one or more components selected from the group consisting of: aqueous ammonia solution, primary amines, secondary amines and amino-ethanol, in an amount of 0.1% by weight to 5% by weight.

2. The composition of claim 1, wherein the ammonia in the aqueous ammonia solution has a concentration of 28-30% by weight.

3. The composition of claim 1 wherein the aqueous ammonia solution is ACS grade.

4. The aqueous composition of claim 1, wherein said microemulsion comprises benzyl alcohol and tripropyleneglycol monomethylether.

5. The aqueous composition of claim 1, wherein said microemulsion comprises benzyl alcohol, tripropyleneglycol monomethylether, neo pentyl glycol, dioctyl sulfosuccinate and sodium salt.

6. The aqueous composition of claim 3, wherein said microemulsion comprises 40 to 50% by weight of benzyl alcohol, 20 to 30% by weight of tripropyleneglycol monomethylether, 5 to 15% by weight of neo pentyl glycol and 14 to 24% by weight of dioctyl sulfosuccinate and sodium salt (we recommend using a range rather than a point for the concentration of the components above).

7. The aqueous composition of claim 1, wherein the microemulsion comprises benzyl alcohol, a nonionic surfactant, an amine component and water.

8. The aqueous composition of claim 6, wherein the microemulsion comprises about 28 to 38% by weight of benzyl alcohol, about 7 to 17% by weight of a nonionic surfactant, about 17 to 27% by weight of an amine component and the balance is water.

9. The aqueous composition of claim 6, wherein the nonionic surfactant is selected from a group comprising alkyl sulfates, alkyl ether sulfates, alkyl ethoxylates, alkali metal salts of sulfo succinates, toluene sulfonates, xylene sulfonates and benzene sulfonates.

10. The aqueous composition of claim 6, wherein the amine component is selected from a group comprising long chained amines, di-amine, cyclic amines, branched di-amines, polyamino substituted alkanes, and C2-C5 alcohol amines.

11. The aqueous composition of claim 6, wherein the amine component is ethanolamine or propanolamine.

12. The aqueous composition of claim 1, wherein said microemulsion is present in an amount of 1.0% by weight to 10% by weight.

13. The aqueous composition of claim 12, wherein said microemulsion is present in an amount of 2% by weight to 7% by weight.

14. The aqueous composition of claim 13, wherein said microemulsion is present in an amount of 3% by weight to 5% by weight.

15. The aqueous composition of claim 1, wherein said one or more components is aqueous ammonium hydroxide.

16. The aqueous composition of claim 14, wherein said aqueous ammonium hydroxide is present in an amount of 0.5% by weight to 3% by weight.

17. The aqueous composition of claim 15, wherein said aqueous ammonium hydroxide is present in an amount of 0.8% by weight to 1.8% by weight.

18. The aqueous composition of claim 1, further comprising an odor masking agent in an amount of 0.01% by weight to 3% by weight.

19. The aqueous composition of claim 18, wherein the odor masking agent is d-limonene.

20. An aqueous composition comprising a microemulsion comprising benzyl alcohol and tripropyleneglycol monomethylether, wherein the microemulsion is provided to the composition in an amount of about 1.0% by weight to about 10% by weight, and further comprising aqueous ammonia solution wherein the ammonia in the aqueous ammonia solution has a concentration of 28-30% by weight, in an amount of 0.1% by weight to 5% by weight.

21. The aqueous composition of claim 20, further comprising an odor masking agent in an amount of 0.01% by weight to 3% by weight.

22. A process for using an aqueous composition comprising a microemulsion and one or more components selected from the group consisting of: aqueous ammonia solution, primary amines, secondary amines and amino-ethanol to remove wax from surfaces comprising: applying the aqueous composition to the surface; and allowing sufficient time for the composition to loosen the wax from the surface, wherein the ammonia in the aqueous ammonia solution has a concentration of 28-30% by weight.
